(19) United States
(12) Patent Application Publication
(10) Pub. No.: US 2024/0346323 A1
(43) Pub. Date: Oct. 17, 2024

(54) SYSTEMS AND METHODS FOR MEASURING THE FAIRNESS OF SCREENING TOOLS IMPLEMENTED BY MACHINE LEARNING

(71) Applicant: MASTERCARD TECHNOLOGIES CANADA ULC, Vancouver (CA)

(72) Inventor: John Hearty, Vancouver (CA)

(21) Appl. No.: 18/633,749

(22) Filed: Apr. 12, 2024

Related U.S. Application Data
(60) Provisional application No. 63/495,971, filed on Apr. 13, 2023.

(51) Int. Cl. G06N 3/09

(52) U.S. Cl. CPC G06N 3/09

(57) ABSTRACT

A system includes memory hardware configured to store instructions and processing hardware configured to execute the instructions. The instructions include loading a first data set, the first data set including (i) a reference profile and (ii) one or more candidate profiles, providing the first data set to a machine learning model to generate output data, generating telemetry for the first data set, the telemetry including (a) one or more role identifiers associated with the reference profile and (b) one or more candidate identifiers associated with the one or more candidate profiles, processing the output data and telemetry to generate a test metric, adjusting parameters of the machine learning model in response to the test metric meeting a first condition, and saving the machine learning model as a validated machine learning model in response to the test metric meeting a second condition.

### CROSS-REFERENCE TO RELATED APPLICATIONS

This application claims the benefit of U.S. Provisional Application No. 63/495,971 filed Apr. 13, 2023. The entire disclosure of the above application is incorporated by reference herein.

### FIELD

The present disclosure relates to error detection and correction in data processing systems and, more particularly, to detecting and correcting systematic errors in artificial intelligence systems.

### SUMMARY

Machine learning technologies generally use algorithms and/or statistical models to analyze and draw inferences from patterns present in data sets. When compared with traditional software solutions, machine learning technologies are especially adept at parsing and making sense of the ever larger and ever more diverse data sets modern enterprises rely on. This is because instead of relying on explicit instructions laying out programming logic that may only be narrowly applicable to particular data sets, machine learning models may be built or trained from the data sets themselves. Thus while traditional software solutions are deterministic and may require extensive manual adjustments to their logical rules when input data sets change, machine learning models may learn from the new data itself. The power, flexibility, and utility of machine learning technologies have led to their being widely adopted by many segments of the modern world. However, because machine learning technologies rely on a training process to learn from data sets, individual machine learning models tend to be accurate only if the training processes are of high quality. Systematic errors in training data sets or in training processes may result in systematically flawed machine learning models that produce inaccurate or unusable results.

One example of a poorly trained machine learning model is one that exhibits bias. Machine learning models may be said to exhibit bias when there are systematic differences between the average productions of the model and reality. As a phenomenon, these biases may stem from erroneous assumptions or systematic flaws in the training process. However, because of the complexity and large size of modern training data sets, it may be difficult to identify these systematic flaws. As machine learning technologies become more widely adopted and relied upon, the harm caused by systematically flawed machine learning models may be widespread. For example, modern resume screening solutions may use machine learning models to match candidate resumes against job descriptions. Such machine learning models may output ranked lists of candidates that are ordered according to their suitability for a role. However, conventional implementations of such models do not include technological solutions suitable for assessing whether their outputs disadvantage candidates based on protected demographic classes. Accordingly, there is a need for techniques and technologies that automatically identify systematic errors—such as biases—in machine learning models, retrains the machine learning models to eliminate the systematic errors, and/or adjusts the outputs of machine learning models to adjust for the systematic errors.

In some aspects, the techniques described herein relate to a system including: memory hardware configured to store instructions; and processing hardware configured to execute the instructions, wherein the instructions include: loading a first data set, the first data set including (i) a reference profile and (ii) one or more candidate profiles, providing the first data set to a machine learning model to generate output data, generating telemetry for the first data set, the telemetry including (a) one or more role identifiers associated with the reference profile and (b) one or more candidate identifiers associated with the one or more candidate profiles, processing the output data and telemetry to generate a test metric, in response to the test metric being below a threshold, adjusting parameters of the machine learning model, and in response to the test metric being greater than or equal to the threshold, saving the machine learning model as a validated machine learning model; wherein the output data includes a candidate list, the candidate list includes candidates identifiers corresponding to the one or more candidate profiles, and the candidate identifiers are ordered according to a mathematical closeness between each respective candidate profile and the reference profile.

In some aspects, the techniques described herein relate to a non-transitory computer-readable storage medium including executable instructions, wherein the executable instructions cause an electronic processor to: load a first data set, the first data set including (i) a reference profile and (ii) one or more candidate profiles; provide the first data set to a machine learning model to generate output data, generate telemetry for the first data set, the telemetry including (a) one or more role identifiers associated with the reference profile and (b) one or more candidate identifiers associated with the one or more candidate profiles; process the output data and telemetry to generate a test metric; in response to the test metric being below a threshold, adjust parameters of the machine learning model; and in response to the test metric being greater than or equal to the threshold, save the machine learning model as a validated machine learning model; wherein the output data includes a candidate list, the candidate list includes candidates identifiers corresponding to the one or more candidate profiles, and the candidate identifiers are ordered according to a mathematical closeness between each respective candidate profile and the reference profile.

In some aspects, the techniques described herein relate to a system including: memory hardware configured to store instructions; and processing hardware configured to execute the instructions, wherein the instructions include: loading a first data set, the first data set including (i) a reference profile and (ii) one or more candidate profiles, providing the first data set to a machine learning model to generate output data, generating telemetry for the first data set, the telemetry including (a) one or more role identifiers associated with the reference profile and (b) one or more candidate identifiers associated with the one or more candidate profiles, processing the output data and telemetry to generate a test metric, in response to the test metric being below a threshold, adjusting the output data, and in response to the test metric being greater than or equal to the threshold, saving the output data as validated output data.

Other examples, embodiments, features, and aspects will become apparent by consideration of the detailed description and accompanying drawings.

### BRIEF DESCRIPTION OF THE DRAWINGS

The present disclosure will become more fully understood from the detailed description and the accompanying drawings.

FIG. 1 is a function block diagram of an example system for evaluating screening tools implemented by machine learning.

FIG. 2 is a function block diagram of an example system for evaluating screening tools implemented by machine learning.

FIG. 3 is a function block diagram of an example system for evaluating screening tools implemented by machine learning.

FIG. 4 is a flowchart of an example process for automatically evaluating and adjusting outputs of machine learning models.

FIG. 5 is a flowchart of an example process for automatically evaluating and adjusting machine learning models.

FIG. 6 is a flowchart of an example process for generating output data from a machine learning model.

FIG. 7 is a flowchart of an example process for generating a test metric.

FIG. 8 is a graphical representation of an example neural network with no hidden layers.

FIG. 9 is a graphical representation of an example neural network with one hidden layer.

In the drawings, reference numbers may be reused to identify similar and/or identical elements.

### DETAILED DESCRIPTION

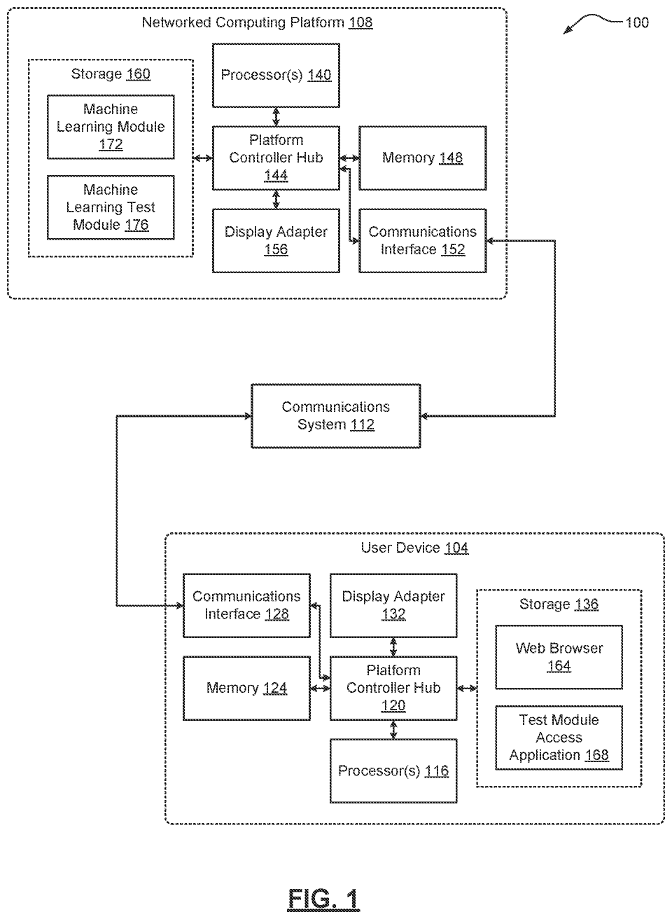

FIGS. 1-3 are function block diagrams of example systems 100 for evaluating screening tools implemented by machine learning. As shown in FIGS. 1-3, examples of the system 100 may be implemented with a user device 104 and a networked computing platform 108. As shown in FIG. 1, the system 100 may include a communications system 112. The user devices of the system 100—such as user device 104 and computer platform 108—may communicate via the communications system 112. Examples of the communications system 112 may include one or more networks, such as a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In various implementations, the communications system 112 may also include an optical network, a local area network, and/or a global communication network, such as the Internet.

As shown in FIGS. 1-3, the user device 104 may include one or more integrated circuits suitable for performing the instructions and tasks involved in computer processing. For example, the user device 104 may include one or more processor(s) 116. The user device 104 may also include one or more electronic chipsets for managing data flow between components of the user device 104. For example, the user device 104 may include a platform controller hub 120. The user device 104 may also include one or more devices or system used to store information for immediate use by other components of the user device 104. For example, the user device 104 may include memory 124. In various implementations, memory 124 may include random-access memory (RAM)—such as non-volatile random-access memory (NVRAM), dynamic random-access memory (DRAM), and static random-access memory (SRAM). The user device 104 may also include a communications interface 128 suitable for communicating with other communications interfaces via the communications system 112. In various implementations, the communications interface 128 may include one or more transceivers suitable for sending and/or receiving data to and from other communications interfaces via the communications system 112.

The user device 104 may include a system suitable for generating a feed of graphics output to a display device. For example, the user device 104 may include a display adapter 132. In various implementations, the display adapter 132 may include one or more graphics processing units that can be used for additional computational processing. In various implementations, the graphics processing units of display adapter 132 may be used to reduce the computational load of the processor(s) 116. The user device 104 may also include one or more non-transitory computer-readable storage media-such as storage 136. In various implementations, storage 136 may include one or more hard disk drives (HDD), single-level cell (SLC) NAND flash, multi-level cell (MLC) NAND flash, triple-level cell (TLC) NAND flash, quad-level cell (QLC) NAND flash, NOR flash, or any other suitable non-volatile memory or non-volatile storage medium accessible by components of the user device 104. One or more software modules-such as web browser 164 and/or test module access application 168—may be stored on storage 136. Instructions of the software modules stored on storage 136 may be executed by the processor(s) 116 and/or display adapter 132.

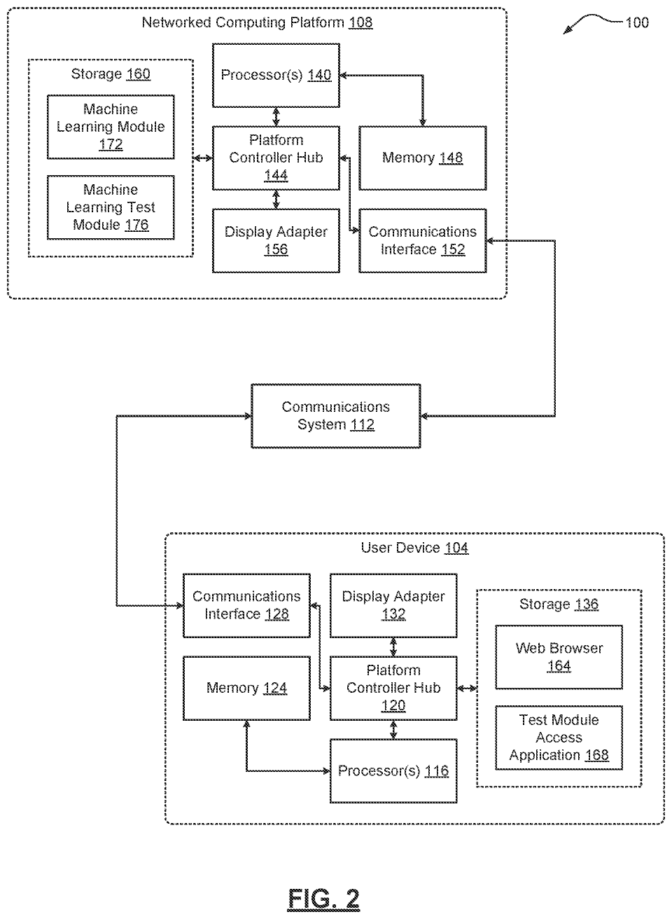

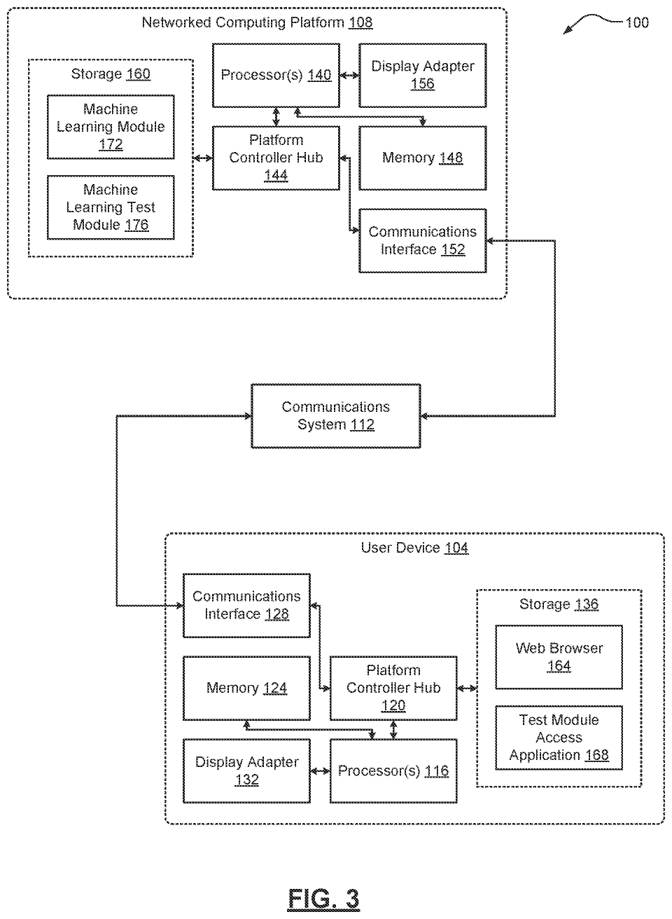

The processor(s) 116, platform controller hub 120, memory 124, communications interface 128, display adapter 132, and/or storage 136 may be operatively coupled to each other. As shown in FIG. 1, in some examples, the processor(s) 116, memory 124, communications interface 128, display adapter 132, and/or storage 136 may be operatively coupled to the platform controller hub 120. In the example of FIG. 1, the platform controller hub 120 functions as a traffic controller between each of the memory 124, communications interface 128, display adapter 132, and/or storage 136 and the processor(s) 116. As shown in FIG. 2, in some examples, the processor(s) 116, communications interface 128, display adapter 132, and/or storage 136 may be operatively coupled to the platform controller hub 120, while the memory 124 is operatively coupled to the processor(s) 116. In the example of FIG. 2, the platform controller hub 120 functions as a traffic controller between each of the communications interface 128, display adapter 132, and/or storage 136 and the processor(s) 116, while the processor(s) 116 may communicate directly with the memory 124. As shown in FIG. 3, in some examples, the processor(s) 116, communications interface 128, and/or storage 136 may be operatively coupled to the platform controller hub 120, while the memory 124 and/or the display adapter 132 are operatively coupled to the processor(s) 116. In the example of FIG. 3, the platform controller hub 120 functions as a traffic controller between each of the communications interface 128 and/or storage 136, while the processor(s) 116 may communicate directly with the memory 124 and/or the display adapter 132.

As shown in FIGS. 1-3, the networked computing platform 108 may include one or more integrated circuits suitable for performing the instructions and tasks involved in computer processing. For example, the networked computing platform 108 may include one or more processor(s) 140. The networked computing platform 108 may also include one or more electronic chipsets for managing data flow between components of the networked computing platform 108. For example, the networked computing platform 108 may include a platform controller hub 144. The networked computing platform 108 may also include one or more devices or system used to store information for immediate use by other components of the networked computing platform 108. For example, the networked computing platform 108 may include memory 148. In various implementations, memory 148 may include random-access memory (RAM)—such as non-volatile random-access memory (NVRAM), dynamic random-access memory (DRAM), and static random-access memory (SRAM). The networked computing platform 108 may also include a communications interface 152 suitable for communicating with other communications interfaces via the communications system 112. In various implementations, the communications interface 152 may include one or more transceivers suitable for sending and/or receiving data to and from other communications interfaces via the communications system 112.

The networked computing platform 108 may include a system suitable for generating a feed of graphics output to a display device. For example, the networked computing platform 108 may include a display adapter 156. In various implementations, the display adapter 156 may include one or more graphics processing units that can be used for additional computational processing. In various implementations, the graphics processing units of display adapter 156 may be used to reduce the computational load of the processor(s) 140. The networked computing platform 108 may also include one or more non-transitory computer-readable storage media-such as storage 160. In various implementations, storage 160 may include one or more hard disk drives (HDD), single-level cell (SLC) NAND flash, multi-level cell (MLC) NAND flash, triple-level cell (TLC) NAND flash, quad-level cell (QLC) NAND flash, NOR flash, or any other suitable non-volatile memory or non-volatile storage medium accessible by components of the networked computing platform 108. One or more software modules-such as machine learning module 172 and/or machine learning test module 176—may be stored on storage 160. Instructions of the software modules stored on storage 160 may be executed by the processor(s) 140 and/or display adapter 156.

The processor(s) 140, platform controller hub 144, memory 148, communications interface 152, display adapter 156, and/or storage 160 may be operatively coupled to each other. As shown in FIG. 1, in some examples, the processor(s) 140, memory 148, communications interface 152, display adapter 156, and/or storage 160 may be operatively coupled to the platform controller hub 144. In the example of FIG. 1, the platform controller hub 144 functions as a traffic controller between each of the memory 148, communications interface 152, display adapter 156, and/or storage 160 and the processor(s) 140. As shown in FIG. 2, in some examples, the processor(s) 140, communications interface 152, display adapter 156, and/or storage 160 may be operatively coupled to the platform controller hub 144, while the memory 148 is operatively coupled to the processor(s) 140. In the example of FIG. 2, the platform controller hub 144 functions as a traffic controller between each of the communications interface 152, display adapter 156, and/or storage 160 and the processor(s) 140, while the processor(s) 140 may communicate directly with the memory 148. As shown in FIG. 3, in some examples, the processor(s) 140, communications interface 152, and/or storage 160 may be operatively coupled to the platform controller hub 144, while the memory 148 and/or the display adapter 156 are operatively coupled to the processor(s) 140. In the example of FIG. 3, the platform controller hub 144 functions as a traffic controller between each of the communications interface 152 and/or storage 160, while the processor(s) 140 may communicate directly with the memory 148 and/or the display adapter 156.

In various implementations, components of the user device 104 may communicate with components of the networked computing platform 108 via the communications system 112. For example, components of the user device 104 may communicate with the communications interface 128, and components of the networked computing platform 108 may communicate with communications interface 152. Communications interface 128 and communications interface 152 may then communicate with each other via the communications system 112.

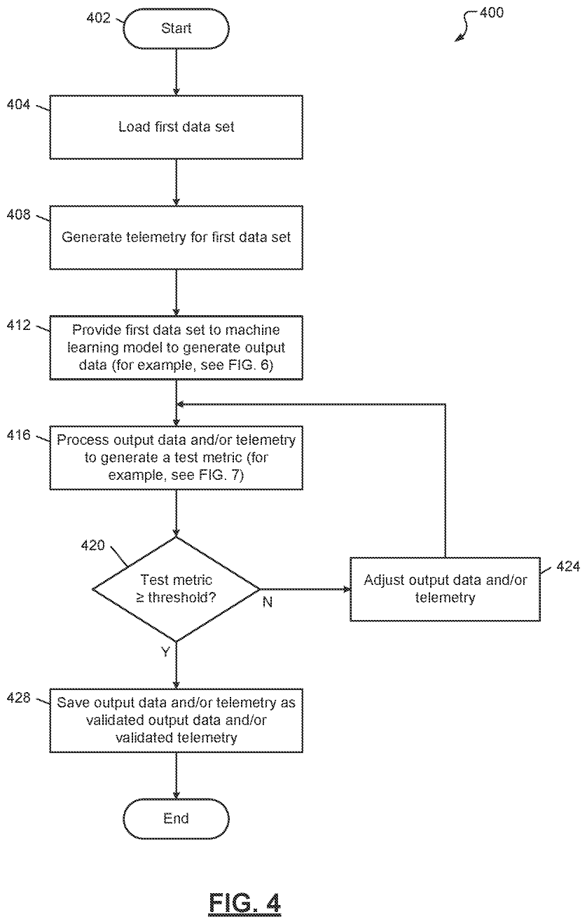

FIG. 4 is a flowchart of an example process 400 for automatically evaluating and adjusting outputs of machine learning models. In various implementations, the system 100 may implement functionality for automatically (i) comparing text of candidate profiles against text of a reference profile, (ii) ranking the candidate profiles according to a mathematical closeness between the text of the candidate profiles and the text of the reference profile, (iii) generating telemetry based on characteristics of the candidate profiles, (iv) evaluating the ranking for systematic errors based on the generated telemetry, and/or (v) adjusting the ranking in order to correct for the systematic errors. In various implementations, the text of the candidate profiles may include text from one or more job applications and/or one or more resumes from each candidate. In some examples, the text of the reference profile may include text from one or more job listings. In various implementations, the system 100 may rank the candidate profiles using one or more machine learning models. In some examples, the one or more machine learning models may include one or more natural language processing models. In various implementations, the one or more machine learning models may include a deep learning model—such as a neural network.

In some examples, the ranking of the candidate profiles may indicate a predicted suitability of each candidate for the job listing. For example, in addition to ranking the candidate profiles, the system 100 may assign a graded score-such as assigning each candidate profile a letter “A” through “E”-indicating a predicted suitability of the candidate profile for the job listing. In various implementations, a letter grade of “A” may indicate a relatively higher predicted suitability of the candidate profile for the job listing, while a letter grade of “E” may indicate a relatively lower predicted suitability. In some examples, the candidate profiles may be ranked in descending order, where the more suitable candidate profiles are closer to the top of the list. In various implementations, the candidate profiles may be ranked in descending order, where the more suitable candidate profiles are closer to the bottom of the list.

In some examples, the telemetry may include: (1) one or more role identifiers associated with the one or more job listings and (2) one or more candidate identifiers associated with each candidate profile. In various implementations, the one or more candidate identifiers may include and/or indicate: (a) a gender associated with each candidate profile, (b) an ethnicity associated with each candidate profile, (c) a protected veteran status associated with each candidate profile, (d) a disability status associated with each candidate profile, and/or (e) an age associated with each candidate profile. In some examples, the systematic errors may include bias —such as negative bias against demographic features associated with the candidate profiles. In various implementations, the one or more candidate identifiers may indicate the demographic features associated with each candidate profile.

As shown in the example of FIG. 4, the example process 400 begins in response to a user inputting a request into web browser 164 and/or test module access application 168 (at start block 402). The web browser 164 and/or test module access application 168 may send a request to machine learning module 172 for the machine learning module 172 to generate an output data set. In some examples, the request may include a first data set. In various implementations, the first data set may include one or more candidate profiles, one or more reference profiles, and/or additional data associated with the one or more candidate profiles suitable for generating telemetry.

The example process 400 includes the machine learning module 172 and/or the machine learning test module 176 loading the first data set (at block 404). In some examples, the machine learning module 172 and/or the machine learning test module 176 receives the first data set from the web browser 164 and/or test module access application 168. In various implementations, the machine learning module 172 and/or the machine learning test module 176 retrieves the first data set from one or more data stores, such as one or more databases located on storage 136 and/or storage 160.

The example process 400 includes the machine learning module 172 and/or the machine learning test module 176 generating telemetry for the first data set (at block 408). In some examples, the machine learning module 172 and/or the machine learning test module 176 may automatically parse the additional data of the first data set and generate telemetry based on the parsed data. In various implementations, the machine learning module 172 and/or the machine learning test module 176 may receive input data from the web browser 164 and/or the test module access application 168 and generate telemetry based on the input data. In some examples, the machine learning module 172 and/or the machine learning test module 176 may send a query to the web browser 164 and/or test module access application 168 for the web browser 164 and/or test module access application 168 to generate a prompt on a graphical user interface for the user. The prompt may request input data from the user. The web browser 164 and/or test module access application 168 may send the input data to the machine learning module 172 and/or the machine learning test module 176.

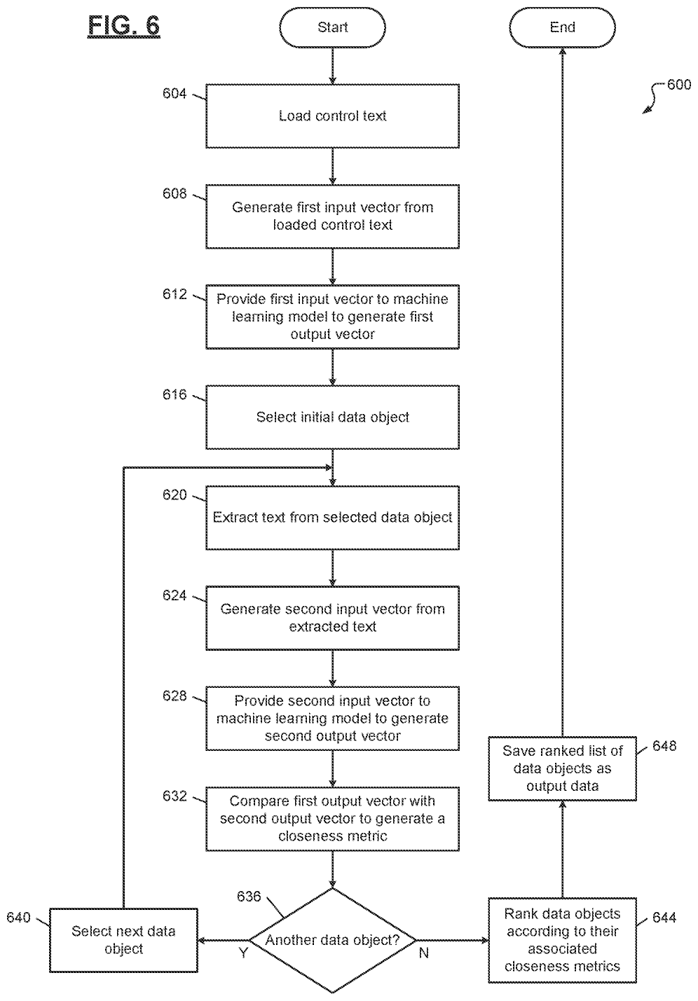

The example process 400 includes the machine learning module 172 providing the first data set as inputs to a machine learning model (e.g., machine learning models described in this specification) to generate output data based on the input first data set (at block 412). As previously described, in various implementations, the output data may include one or more ordered lists ranking candidate profiles according to their suitability for one or more job listings. In some examples, the output data may also include a graded score for each candidate profile. Additional details of generating output data using the machine learning model will be described further on in this specification with reference to FIG. 6.

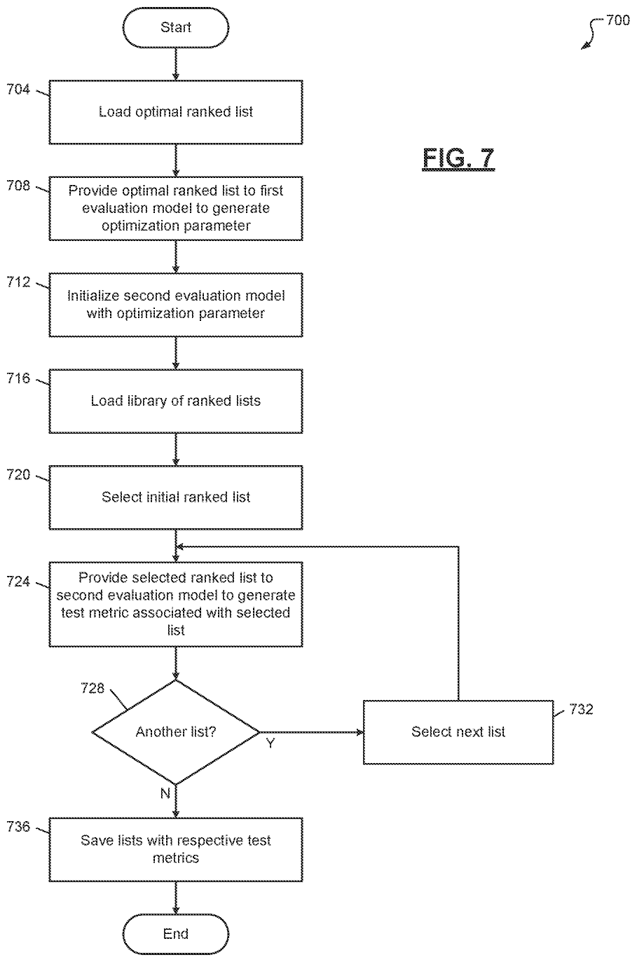

The example process 400 includes the machine learning test module 172 processes the output data from the machine learning model and/or telemetry to generate a test metric (at block 416). In various implementations, the test metric may include a score indicating a level of systematic error present in the output data. In some examples, disparate impact analysis methodology may be used to generate the test metric. In some examples where disparate impact analysis methodology is used, a hard boundary (e.g., the top p cases) may be assigned, and the boundary may be treated as a binary class threshold. For example, p may be 6. In various implementations, normalized discounted difference methodology may be used to generate the test metric. Additional details of generating the test metric will be described further on in this specification with reference to FIG. 7.

The example process 400 includes the machine learning test module 176 determining whether the test metric is greater than or equal to a threshold (at decision block 420). In various implementations, the threshold may be a numerical value of about 0. When the machine learning test module 176 determines that the test metric is not greater than or equal to the threshold (“NO” at decision block 420), the machine learning test module 176 adjusts the output data and/or telemetry (at block 424). For example, the machine learning test module 176 may adjust the order of candidate profiles within the ranked list of the output data. After adjusting the output data and/or the telemetry (at block 424), the machine learning test module 176 again processes the output data from the machine learning model and/or telemetry to generate a test metric (at block 416).

When the machine learning test module 176 determines that the test metric is greater than or equal to the threshold (“YES” at decision block 420), the machine learning test module 176 saves the output data and/or telemetry as validated output data and/or validated telemetry (at block 428). In some examples, the machine learning test module 176 may save the output data and/or telemetry to one or more data stores, such as storage 136 and/or storage 160. In various implementations, the machine learning test module 176 may send the validated output data and/or the validated telemetry to the web browser 164 and/or the test module access application 168, and the web browser 164 and/or the test module access application 168 may transform the graphical user interface to display the validated output data and/or the validated telemetry to the user via the graphical user interface.

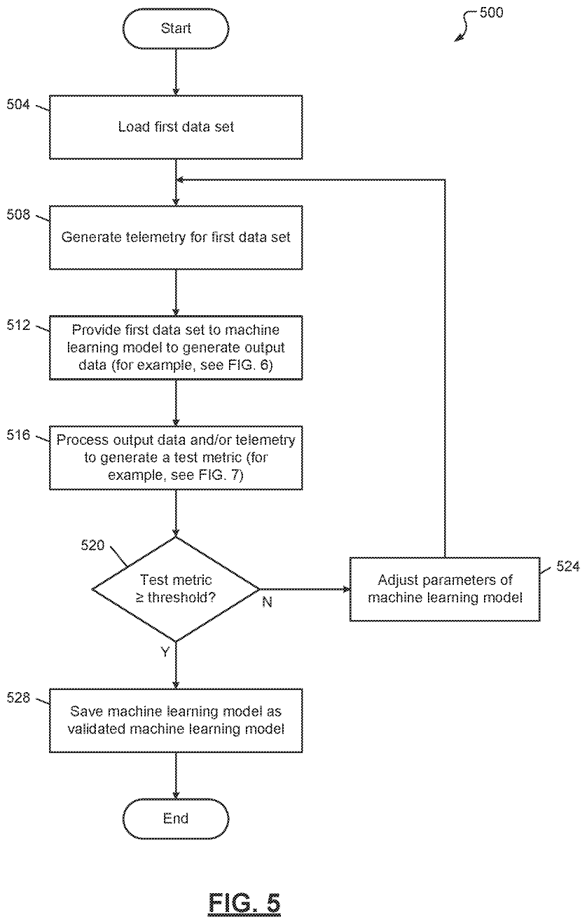

FIG. 5 is a flowchart of an example process 500 for automatically evaluating and adjusting machine learning models. As previously discussed, the system 100 may implement functionality for automatically (i) comparing text of candidate profiles against text of a reference profile, (ii) ranking the candidate profiles according to a mathematical closeness between the text of the candidate profiles and the text of the reference profile, (iii) generating telemetry based on characteristics of the candidate profiles, (iv) evaluating the ranking for systematic errors based on the generated telemetry, and/or (v) adjusting the machine learning model in order to correct for the systematic errors caused by less-than-optimal configuration parameters of the machine learning model. In some examples, the text of the candidate profiles may include text from one or more job applications and/or one or more resumes from each candidate. In various implementations, the text of the reference profile may include text from one or more job listings. In some examples, the system 100 may rank the candidate profiles using one or more machine learning models. In various implementations, the one or more machine learning models may include one or more natural language processing models. In some examples, the one or more machine learning models may include a deep learning model-such as a neural network.

In various implementations, the ranking of the candidate profiles may indicate a predicted suitability of each candidate for the job listing. For example, in addition to ranking the candidate profiles, the system 100 may assign a graded score-such as assigning each candidate profile a letter “A” through “E”-indicating a predicted suitability of the candidate profile for the job listing. In some examples, a letter grade of “A” may indicate a relatively higher predicted suitability of the candidate profile for the job listing, while a letter grade of “E” may indicate a relatively lower predicted suitability. In various implementations, the candidate profiles may be ranked in descending order, where the more suitable candidate profiles are closer to the top of the list. In some examples, the candidate profiles may be ranked in descending order, where the more suitable candidate profiles are closer to the bottom of the list.

In various implementations, the telemetry may include: (1) one or more role identifiers associated with the one or more job listings and (2) one or more candidate identifiers associated with each candidate profile. In some examples, the one or more candidate identifiers may include and/or indicate: (a) a gender associated with each candidate profile, (b) an ethnicity associated with each candidate profile, (c) a protected veteran status associated with each candidate profile, (d) a disability status associated with each candidate profile, and/or (c) an age associated with each candidate profile. In various implementations, the systematic errors may include bias-such as negative bias against demographic features associated with the candidate profiles. In some examples, the one or more candidate identifiers may indicate the demographic features associated with each candidate profile.

As shown in FIG. 5, the example process 500 beings in response to a user inputting a request into web browser 164 and/or test module access application 168 (at start block 402). The web browser 164 and/or test module access application 168 may send a request to machine learning module 172 for the machine learning module 172 to generate an output data set. In various implementations, the request may include a first data set. In some examples, the first data set may include one or more candidate profiles, one or more reference profiles, and/or additional data associated with the one or more candidate profiles suitable for generating telemetry.

The example process 500 includes the machine learning module 172 and/or the machine learning test module 176 loading the first data set (at block 504). In various implementations, the machine learning module 172 and/or the machine learning test module 176 receives the first data set from the web browser 164 and/or test module access application 168. In some examples, the machine learning module 172 and/or the machine learning test module 176 retrieves the first data set from one or more data stores, such as one or more databases located on storage 136 and/or storage 160.

The example process 500 includes the machine learning module 172 and/or the machine learning test module 176 generating telemetry for the first data set (at block 508). In various implementations, the machine learning module 172 and/or the machine learning test module 176 may automatically parse the additional data of the first data set and generate telemetry based on the parsed data. In some examples, the machine learning module 172 and/or the machine learning test module 176 may receive input data from the web browser 164 and/or the test module access application 168 and generate telemetry based on the input data. In various implementations, the machine learning module 172 and/or the machine learning test module 176 may send a query to the web browser 164 and/or test module access application 168 for the web browser 164 and/or test module access application 168 to generate a prompt on a graphical user interface for the user. The prompt may request input data from the user. The web browser 164 and/or test module access application 168 may send the input data to the machine learning module 172 and/or the machine learning test module 176.

The example process 500 includes the machine learning module 172 providing the first data set as inputs to a machine learning model-such as machine learning models described in this specification (at block 512). The machine learning model then generates output data based on the input first data set. As previously described, in some examples, the output data may include one or more ordered lists ranking candidate profiles according to their suitability for one or more job listings. In various implementations, the output data may also include a graded score for each candidate profile. Additional details of generating output data using the machine learning model will be described further on in this specification with reference to FIG. 6.

The example process 500 includes the machine learning test module processing the output data from the machine learning model and/or telemetry to generate a test metric (at block 516). In some examples, the test metric may include a score indicating a level of systematic error present in the output data. In various implementations, disparate impact analysis methodology may be used to generate the test metric. In some examples where disparate impact analysis methodology is used, a hard boundary (e.g., the top p cases) may be assigned, and the boundary may be treated as a binary class threshold. For example, p may be 6. In various implementations, normalized discounted difference methodology may be used to generate the test metric. Additional details of generating the test metric will be described further on in this specification with reference to FIG. 7.

The example process 500 includes the machine learning test module 176 determining whether the test metric is greater than or equal to a threshold (at block 520). In some examples, the threshold may be a numerical value of about 0. When the machine learning test module 176 determines that the test metric is not greater than or equal to the threshold (“NO” at decision block 520), the machine learning test module 176 adjusts parameters of the machine learning model (at block 524). After adjusting the output data and/or the telemetry (at block 524), the machine learning test module 176 again processes the output data from the machine learning model and/or telemetry to generate a test metric (at block 516).

When the machine learning test module 176 determines that the test metric is greater than or equal to the threshold (“YES” at decision block 520), the machine learning test module 176 saves the machine learning model as a validated machine learning model (at block 528). In various implementations, the machine learning model may be considered a “validated machine learning model” after (i) it has been technically evaluated for systematic errors and (ii) any systematic errors have been minimized or eliminated. In some examples, the validated machine learning model may be saved to one or more data stores, such as storage 136 and/or storage 160.

FIG. 6 is a flowchart of an example process 600 for generating output data from a machine learning model. The example process 600 includes the machine learning module 172 loading a control text (at block 604). In various implementations, the machine learning module 172 may load text from the reference profile of the first data set. The example process 600 includes the machine learning module 172 generating a first input vector from the loaded control text. In some examples, the machine learning module 172 may perform one or more preprocessing operations on the loaded control text. For example, preprocessing operations may include tokenization, lemmatization, stemming, bag-of-words, term frequency-inverse document frequency (TF-IDF), normalization, and/or noise removal operations on the loaded control text. The machine learning module 172 may then vectorize the preprocessed text and generate a first input vector. The example process 600 includes the machine learning module 172 providing the first input vector to the machine learning model to generate a first output vector (at block 612).

The example process 600 includes the machine learning module 172 selecting an initial data object (at block 616). In various implementations, the initial data object may include an initial candidate profile from the loaded first data set. The example process 600 includes the machine learning module 172 extracting text from the selected data object (at block 620). In some examples, the machine learning module 172 extracts text from text associated with the selected candidate profile. The example process 600 includes the machine learning module 172 generating a second input vector from the extracted text (at block 624). In various implementations, the machine learning module 172 may perform one or more preprocessing operations-such as those previously described with reference to block 608. The example process 600 includes the machine learning module 172 providing the second input vector to the machine learning model to generate a second output vector (at block 628). The example process 600 includes the machine learning module 172 comparing the first output vector with the second output vector to generate a closeness metric (at block 632). In some examples, the closeness metric may indicate a mathematical closeness between the text of the reference profile and the text of the selected candidate profile. In various implementations, the closeness metric may be generated by calculating a cosine similarity between the first output vector and the second output vector. In such implementations, the closer the closeness metric is to 1, the more similar the text of the reference profile and the text of the selected candidate profile may be. Conversely, the closer the closeness metric is to 0, the more dissimilar the text of the reference profile and the text of the selected candidate profile may be.

The process 600 includes the machine learning module 172 determining whether another data object is present (at block 636). For example, the machine learning module 172 may determine that another data object is present if another candidate profile that has not been processed is present in the first data set. When the machine learning module 172 determines that another data object is present (“YES” at decision block 636), the machine learning module 172 selects the next data object (at block 640). In various implementations, the machine learning module 172 selects the next candidate profile from the loaded first data set. After selecting the next data object (at block 640), the machine learning module 172 again extracts text from the selected data object (at block 620).

When the machine learning module 172 determines that another data object is not present (“NO” at decision block 636), the machine learning module 172 ranks the data objects according to their associated closeness metrics (at block 644). In some examples, candidate profiles having closeness metrics indicating that they are more similar to the reference profile may be positioned higher than candidate profiles having closeness metrics indicating that they are less similar to the reference profile. In various implementations where the closeness metrics are calculated by taking a cosine similarity between the first output vector and the second output vector, candidate profiles having closeness metrics closer to 1 may be positioned above candidate profiles having closeness metrics closer to 0. In some examples, candidate profiles having numerically greater closeness metrics may be positioned above candidate profiles having numerically smaller closeness metrics. The example process 600 includes the machine learning module 172 saving the ranked lists of data objects as output data (at block 648). In various implementations, the output data may be saved to one or more data stores, such as storage 136 and/or storage 160.

FIG. 7 is a flowchart of an example process 700 for generating a test metric. The example process 700 includes the machine learning test module 176 loading an optimal ranked list (at block 704). In various implementations, the optimal ranked list may include a list showing an optimal ranking of candidate profiles. In some examples, the optimal list may include all of the candidate profiles present in the first data set. In various implementations, the optimal list may include telemetry associated with each candidate profile-such as whether each candidate profile belongs to (a) a protected gender group, (b) a protected ethnic group, (c) a protected veteran group, (d) a protected disability group, and/or (e) a protected age group. The example process 700 includes the machine learning test module 176 providing the optimal ranked list to a first evaluation model to generate an optimization parameter. In some examples, an optimization parameter may be generated for each protected group. In various implementations, the first evaluation model may generate the optimization parameter opt_rND according to equation (1) below:

$$opt\_rND = \frac{1}{{log}_{2} ( p )} \vert \frac{\vert {G}_{1 … p}^{+} \vert}{p} - \frac{\vert {G}^{+} \vert}{N} \vert . \qquad ( 1 )$$

In equation (1), p indicates a position in the list, |G_{1 . . . p}⁺| is the number of items in the top p positions of the optimal ranked list that belong to a selected protected group, |G⁺| is the number of items in the optimal ranked list that belong to the selected protected group, and N is a total number of items in the optimal ranked list. In various implementations, p may correspond to the number of relevant positions on a list. For example, if only the top 6 candidates on a ranked list will be considered for a position, p may be set to 6.

In some examples, the first evaluation model may generate the optimization parameter opt_rND according to equation (2) below:

$$opt\_rND = \frac{1}{p} {\sum }_{i = 1}^{p} \frac{1}{{log}_{2} ( i )} \vert \frac{\vert {G}_{1 … i}^{+} \vert}{i} - \frac{\vert {G}^{+} \vert}{N} \vert . \qquad ( 2 )$$

In equation (2), p indicates the position in the list, |G_{1 . . . p}⁺| is the number of items in the top p positions of the optimal ranked list that belong to a selected protected group, |G⁺| is the number of items in the optimal ranked list that belong to the selected protected group, and N is a total number of items in the optimal ranked list. Equation (2) is similar to equation (1) except that instead of computing a single optimization parameter opt_rND according to equation (1) using p as the argument, equation (2) shows that the optimization parameter opt_rND may be computed by applying the optimization function opt_rND of equation (1) to each integer starting from 1 up to p (e.g., resulting in p output values), summing the p output values, and dividing the sum by p (e.g., averaging the p output values).

After the optimization parameter opt_rND is generated (at block 708), the machine learning test module 176 initializes a second optimization model with the optimization parameter opt_rND (at block 712). In various implementations, the optimization parameter opt_rND (e.g., computed according to equation (1) or equation (2) above) may be provided as a constant to equation (3) below to output a test metric rND:

$$rND = \frac{1}{opt\_rND} {\sum }_{p}^{N} \frac{1}{{log}_{2} ( p )} \vert \frac{\vert {G}_{1 … p}^{+} \vert}{p} - \frac{\vert {G}^{+} \vert}{N} \vert . \qquad ( 3 )$$

The example process 700 includes the machine learning test module 176 loading a library of ranked lists (at block 716). In some examples, each ranked list of the library of ranked lists may be a ranked list of candidate profiles. In various implementations, each ranked list may be generated according to the previously described processes of FIGS. 4-6. In some examples, each ranked list may include telemetry associated with each candidate profile. The example process 700 includes the machine learning test module 176 selecting an initial ranked list from the library of ranked lists (at block 720). The example process 700 includes the machine learning test module 176 providing the selected ranked list to the initialized second evaluation model—such as the model described by equation (3) above—to generate a test metric associated with the selected list. In various implementations, the test metric may be the output rND of equation (3) above. In some examples, a single test metric—such as output rND—may be generated for each ranked list. In various implementations, the test metric may represent an unconstrained value of bias between (i) the top p values of the ranked list and (ii) the optimal ranked list. By comparing the demographic categorical distribution of these two lists, it is possible to determine whether (a) distribution on the ranked list is negatively affected by demographic group membership—such as membership in the selected protected group—and (b) a relative degree to which distribution on the list is affected by demographic group membership.

The process 700 includes the machine learning test module 176 determining whether another list that has not been processed is present in the library of ranked lists (at decision block 728). When the machine learning test module 176 determines that another list that has not been processed is present in the library of ranked lists (“YES” at decision block 728), the machine learning test module 176 selects the next list from the library of ranked lists (at block 732) and provides the selected ranked list to the second evaluation model to generate a test metric associated with the selected list (at block 724). When the machine learning test module 176 determines that another list that has not been processed is not present in the library of ranked lists (“NO” at decision block 728), the machine learning test module 176 saves the ranked lists of the library of ranked lists with their respective test metrics (at block 736). In some examples, the ranked lists and test metrics may be saved to one or more data stores, such as storage 136 and/or storage 160.

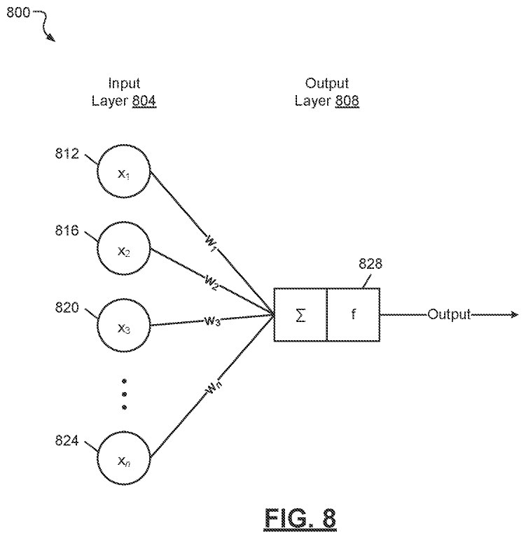

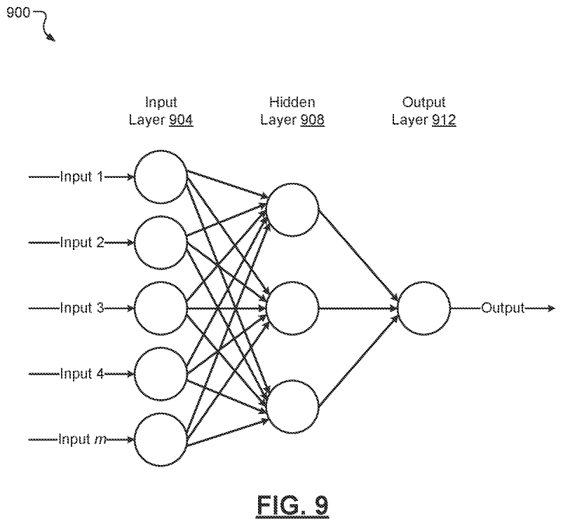

FIG. 8 is a graphical representation of an example neural network with no hidden layers. Any of the previously described machine learning models may be implemented as a neural network in accordance with the principles described with reference to FIGS. 8 and 9. Generally, neural networks may include an input layer, an output layer, and any number—including none—of hidden layers between the input layer and the output layer. Each layer of the machine learning model may include one or more nodes with each node representing a scalar. Input variables may be provided to the input layer. Any hidden layers and/or the output layer may transform the inputs into output variables, which may then be output from the neural network at the output layer. In some examples, the input variables to the neural network may be an input vector having dimensions equal to the number of nodes in the input layer. In various implementations, the output variables of the neural network may be an output vector having dimensions equal to the number of nodes in the output layer.

Generally, the number of hidden layers—and the number of nodes in each layer—may be selected based on the complexity of the input data, time complexity requirements, and accuracy requirements. Time complexity may refer to an amount of time required for the neural network to learn a problem—which can be represented by the input variables—and produce acceptable results—which can be represented by the output variables. Accuracy may refer to how close the results represented by the output variables are to real results. In some examples, increasing the number of hidden layers and/or increasing the number of nodes in each layer may increase the accuracy of neural networks but also increase the time complexity. Conversely, in various implementations, decreasing the number of hidden layers and/or decreasing the number of nodes in each layer may decrease the accuracy of neural networks but also decrease the time complexity.

As shown in FIG. 8, some examples of neural networks, such as neural network 800, may have no hidden layers. Neural networks with no hidden layers may be suitable for solving problems with input variables that represent linearly separable data. For example, if data can be represented by sets of points existing in a Euclidean plane, then the data may be considered linearly separable if the sets of points can be divided by a single line in the plane. If the data can be represented by sets of points existing in higher-dimensional Euclidean spaces, the data may be considered linearly separable if the sets can be divided by a single plane or hyperplane. Thus, in some examples, the neural network 800 may function as a linear classifier and may be suitable for performing linearly separable decisions or functions.

As shown in FIG. 8, the neural network 800 may include an input layer—such as input layer 804, an output layer—such as output layer 808, and no hidden layers. Data may flow forward in the neural network 800 from the input layer 804 to the output layer 808, and the neural network 800 may be referred to as a feedforward neural network. Feedforward neural networks having no hidden layers may be referred to as single-layer perceptrons. In various implementations, the input layer 804 may include one or more nodes, such as nodes 812-824. Although only four nodes are shown in FIG. 8, the input layer 804 may include any number of nodes, such as n nodes. In some examples, each node of the input layer 804 may be assigned any numerical value. For example, node 812 may be assigned a scalar represented by x₁, node 816 may be assigned a scalar represented by x₂, node 820 may be assigned a scalar represented by x₃, and node 824 may be assigned a scalar represented by xₙ.

In various implementations, each of the nodes 812-824 may correspond to an element of the input vector. For example, the input variables to a neural network may be expressed as input vector i having n dimensions. So for neural network 800—which has an input layer 804 with nodes 812-824 assigned scalar values x₁-xₙ, respectively-input vector i may be represented by equation (3) below:

$$i = 〈 {x}_{1} , {x}_{2} , {x}_{3} , {x}_{n} 〉 . \qquad ( 3 )$$

In various implementations, input vector i may be a signed vector, and each element may be a scalar value in a range of between about −1 and about 1. So, in some examples, the ranges of the scalar values of nodes 812-824 may be expressed in interval notation as: x₁ ∈[−1,1], x₂ ∈[−1,1], x₃ ∈[−1,1], and xₙ ∈[−1,1].

Each of the nodes of a previous layer of a feedforward neural network—such as neural network 800—may be multiplied by a weight before being fed into one or more nodes of a next layer. For example, the nodes of the input layer 804 may be multiplied by weights before being fed into one or more nodes of the output layer 808. In various implementations, the output layer 808 may include one or more nodes, such as node 828. While only a single node is shown in FIG. 8, the output layer 808 may have any number of nodes. In the example of FIG. 8, node 812 may be multiplied by a weight w₁ before being fed into node 828, node 816 may be multiplied by a weight w₂ before being fed into node 828, node 820 may be multiplied by a weight w₃ before being fed into node 828, and node 824 may be multiplied by a weight wₙ before being fed into node 828. At each node of the next layer, the inputs from the previous layer may be summed, and a bias may be added to the sum before the summation is fed into an activation function. The output of the activation function may be the output of the node.

In various implementations—such as in the example of FIG. 8, the summation of inputs from the previous layer may be represented by Σ. In some examples, if a bias is not added to the summed outputs of the previous layer, then the summation Σ may be represented by equation (4) below:

$$\sum = {x}_{1} {w}_{1} + {x}_{2} {w}_{2} + {x}_{3} {w}_{3} + {x}_{n} {w}_{n} . \qquad ( 4 )$$

In various implementations, if a bias b is added to the summed outputs of the previous layer, then summation Σ may be represented by equation (5) below:

$$\sum = {x}_{1} {w}_{1} + {x}_{2} {w}_{2} + {x}_{3} {w}_{3} + {x}_{n} {w}_{n} + b . \qquad ( 5 )$$

The summation Σ may then be fed into activation function ƒ. In some examples, the activation function ƒ may be any mathematical function suitable for calculating an output of the node. Example activation functions ƒ may include linear or non-linear functions, step functions such as the Heaviside step function, derivative or differential functions, monotonic functions, sigmoid or logistic activation functions, rectified linear unit (ReLU) functions, and/or leaky ReLU functions. The output of the function ƒ may then be the output of the node. In a neural network with no hidden layers—such as the single-layer perceptron shown in FIG. 8—the output of the nodes in the output layer may be the output variables or output vector of the neural network. In the example of FIG. 8, the output of node 828 may be represented by equation (6) below if the bias b is not added, or equation (7) below if the bias b is added:

$$Output = f ( {x}_{1} {w}_{1} + {x}_{2} {w}_{2} + {x}_{3} {w}_{3} + {x}_{n} {w}_{n} ) , \qquad ( 6 )$$

$$and$$

$$Output = f ( {x}_{1} {w}_{1} + {x}_{2} {w}_{2} + {x}_{3} {w}_{3} + {x}_{n} {w}_{n} + b ) . \qquad ( 7 )$$

Thus, as neural network 800 is illustrated in FIG. 8 with an output layer 808 having only a single node 828, the output vector of neural network 800 is a one-dimensional vector (e.g., a scalar). However, as the output layer 808 may have any number of nodes, the output vector may have any number of dimensions.

FIG. 9 is a graphical representation of an example neural network with one hidden layer. Neural networks with one hidden layer may be suitable for performing continuous mapping from one finite space to another. Neural networks having two hidden layers may be suitable for approximating any smooth mapping to any level of accuracy. As shown in FIG. 9, the neural network 900 may include an input layer—such as input layer 904, a hidden layer—such as hidden layer 908, and an output layer—such as output layer 912. In the example of FIG. 9, each node of a previous layer of neural network 900 may be connected to each node of a next layer. So, for example, each node of the input layer 904 may be connected to each node of the hidden layer 908, and each node of the hidden layer 908 may be connected to each node of the output layer 912. Thus, the neural network shown in FIG. 9 may be referred to as a fully-connected neural network. However, while neural network 900 is shown as a fully-connected neural network, each node of a previous layer does not necessarily need to be connected to each node of a next layer. A feedforward neural network having at least one hidden layer-such as neural network 900—may be referred to as a multilayer perceptron.

In a manner analogous to neural networks described with reference to FIG. 8, input vectors for neural network 900 may be m-dimensional vectors, where m is a number of nodes in input layer 904. Each element of the input vector may be fed into a corresponding node of the input layer 904. Each node of the input layer 904 may then be assigned a scalar value corresponding to the respective element of the input vector. Each node of the input layer 904 may then feed its assigned scalar value—after it is multiplied by a weight—to one or more nodes of the next layer, such as hidden layer 908. Each node of hidden layer 908 may take a summation of its inputs (e.g., a weighted summation of the nodes of the input layer 904) and feed the summation into an activation function. In various implementations, a bias may be added to the summation before it is fed into the activation function. In some examples, the output of each node of the hidden layer 908 may be calculated in a manner similar or analogous to that described with respect to the output of node 828 of FIG. 8.

Each node of the hidden layer 908 may then feed its output—after it is multiplied by a weight—to one or more nodes of the next layer, such as output layer 912. Each node of the output layer 912 may take a summation of its inputs (e.g., a weighted summation of the outputs of the nodes of hidden layer 908) and feed the summation into an activation function. In various implementations, a bias may be added to the summation before it is fed into the activation function. In some examples, the output of each node of the output layer 912 may be calculated in a manner similar or analogous to that described with respect to the output of node 828 of FIG. 8. The output of the nodes of the output layer 912 may be the output variables or the output vector of neural network 900. While only a single hidden layer is shown in FIG. 9, neural network 900 may include any number of hidden layers. A weighted summation of the outputs of each previous hidden layer may be fed into nodes of the next hidden layer, and a weighted summation of the outputs of those nodes may be fed into a further hidden layer. A weighted summation of the outputs of a last hidden layer may be fed into nodes of the output layer.

The following paragraphs provide examples of systems, methods, and devices implemented in accordance with this specification.

Example 1. A system comprising: memory hardware configured to store instructions; and processing hardware configured to execute the instructions, wherein the instructions include: loading a first data set, the first data set including (i) a reference profile and (ii) one or more candidate profiles, providing the first data set to a machine learning model to generate output data, generating telemetry for the first data set, the telemetry including (a) one or more role identifiers associated with the reference profile and (b) one or more candidate identifiers associated with the one or more candidate profiles, processing the output data and telemetry to generate a test metric, in response to the test metric being below a threshold, adjusting parameters of the machine learning model, and in response to the test metric being greater than or equal to the threshold, saving the machine learning model as a validated machine learning model; wherein the output data includes a candidate list, the candidate list includes candidates identifiers corresponding to the one or more candidate profiles, and the candidate identifiers are ordered according to a mathematical closeness between each respective candidate profile and the reference profile.

Example 2. The system of example 1, wherein providing the first data set to the machine learning model to generate output data includes: extracting a control text from the reference profile; generating a first input vector from the control text; and providing the first input vector to the machine learning model to generate a first output vector.

Example 3. The system of example 2, wherein providing the first data set to the machine learning model to generate output data includes: extracting a candidate text from the one or more candidate profiles; generating a second input vector from the control text; and providing the second input vector to the machine learning model to generate a second output vector.

Example 4. The system of example 3, wherein providing the first data set to the machine learning model to generate output data includes comparing the first output vector with the second output vector to generate a closeness vector.

Example 5. The system of example 4, wherein processing the output data and telemetry to generate a test metric includes: providing an optimal ranked list to a first evaluation model to generate an optimization parameter; initializing a second evaluation model with the optimization parameter; and providing the candidate list to the second evaluation model to generate the test metric.

Example 6. The system of example 5, wherein: the first evaluation model generates the optimization parameter according to

$$opt\_rND = \frac{1}{{log}_{2} ( p )} \vert \frac{\vert {G}_{1 … p}^{+} \vert}{p} - \frac{\vert {G}^{+} \vert}{N} \vert ;$$

opt_rND is the optimization parameter; p indicates a number of positions on the optimal ranked list; |G_{1 . . . p}⁺| indicates a number of items in a top p positions on the optimal ranked list that belong to a protected class; |G⁺| indicates a number of items on the optimal ranked list that belong to the protected class; and N indicates a total number of items on the optimal ranked list.

Example 7. The system of example 5, wherein: the first evaluation model generates the optimization parameter according to

$$opt\_rND = \frac{1}{p} {\sum }_{i = 1}^{p} \frac{1}{{log}_{2} ( i )} \vert \frac{\vert {G}_{1 … i}^{+} \vert}{i} - \frac{\vert {G}^{+} \vert}{N} \vert ;$$

opt_rND is the optimization parameter; p indicates a number of positions on the optimal ranked list; |G_{1 . . . p}⁺| indicates a number of items in a top p positions on the optimal ranked list that belong to a protected class; |G⁺| indicates a number of items on the optimal ranked list that belong to the protected class; and N indicates a total number of items on the optimal ranked list.

Example 8. The system of example 7, wherein the second evaluation model generates the test metric according to

$$rND = \frac{1}{opt\_rND} {\sum }_{p}^{N} \frac{1}{{log}_{2} ( p )} \vert \frac{\vert {G}_{1 … p}^{+} \vert}{p} - \frac{\vert {G}^{+} \vert}{N} \vert ,$$

and wherein rND is the test metric.

Example 9. The system of example 8, wherein the machine learning model is a trained neural network including: an input layer having a plurality of nodes; one or more hidden layers having a plurality of nodes; and an output layer having a plurality of nodes; wherein: each node of the input layer is connected to at least one node of the one or more hidden layers, each node of the input layer represents a numerical value, the at least one node of the one or more hidden layers receives the numerical value multiplied by a weight as an input, the at least one node of the one or more hidden layers receives the numerical value multiplied by the weight and offset by a bias as the input; and wherein the at least one node of the one or more hidden layers is configured to: sum inputs received from nodes of the input layer, provide the summed inputs to an activation function, and provide an output of the activation function to one or more nodes of a next layer.

Example 10. A non-transitory computer-readable storage medium comprising executable instructions, wherein the executable instructions cause an electronic processor to: load a first data set, the first data set including (i) a reference profile and (ii) one or more candidate profiles; provide the first data set to a machine learning model to generate output data, generate telemetry for the first data set, the telemetry including (a) one or more role identifiers associated with the reference profile and (b) one or more candidate identifiers associated with the one or more candidate profiles; process the output data and telemetry to generate a test metric; in response to the test metric being below a threshold, adjust parameters of the machine learning model; and in response to the test metric being greater than or equal to the threshold, save the machine learning model as a validated machine learning model; wherein the output data includes a candidate list, the candidate list includes candidates identifiers corresponding to the one or more candidate profiles, and the candidate identifiers are ordered according to a mathematical closeness between each respective candidate profile and the reference profile.

Example 11. The non-transitory computer-readable storage medium of example 10, wherein the executable instructions cause the electronic processor to provide the first data set to the machine learning model to generate output data by: extracting a control text from the reference profile; generating a first input vector from the control text; and providing the first input vector to the machine learning model to generate a first output vector.

Example 12. The non-transitory computer-readable storage medium of example 11, wherein the executable instructions cause the electronic processor to provide the first data set to the machine learning model to generate output data by: extracting a candidate text from the one or more candidate profiles; generating a second input vector from the control text; and providing the second input vector to the machine learning model to generate a second output vector.

Example 13. The non-transitory computer-readable storage medium of example 12, wherein providing the first data set to the machine learning model to generate output data includes comparing the first output vector with the second output vector to generate a closeness vector.

Example 14. The non-transitory computer-readable storage medium of example 13, wherein the executable instructions cause the electronic processor to process the output data and telemetry to generate a test metric by: providing an optimal ranked list to a first evaluation model to generate an optimization parameter; initializing a second evaluation model with the optimization parameter; and providing the candidate list to the second evaluation model to generate the test metric.

Example 15. The non-transitory computer-readable storage medium of example 14, wherein: the first evaluation model generates the optimization parameter according to

$$opt\_rND = \frac{1}{{log}_{2} ( p )} \vert \frac{\vert {G}_{1 … p}^{+} \vert}{p} - \frac{\vert {G}^{+} \vert}{N} \vert ;$$

opt_rND is the optimization parameter; p indicates a number of positions on the optimal ranked list; |G_{1 . . . p}⁺| indicates a number of items in a p top positions on the optimal ranked list that belong to a protected class; |G⁺| indicates a number of items on the optimal ranked list that belong to the protected class; and N indicates a total number of items on the optimal ranked list.

Example 16. The non-transitory computer-readable storage medium of example 15, wherein: the first evaluation model generates the optimization parameter according to

$$opt\_rND = \frac{1}{p} {\sum }_{i = 1}^{p} \frac{1}{{log}_{2} ( i )} \vert \frac{\vert {G}_{1 … i}^{+} \vert}{i} - \frac{\vert {G}^{+} \vert}{N} \vert ;$$

number of positions on the optimal ranked list; |G_{1 . . . p}⁺| indicates a number of items in a top p positions on the optimal ranked list that belong to a protected class; |G⁺| indicates a number of items on the optimal ranked list that belong to the protected class; and N indicates a total number of items on the optimal ranked list.

Example 17. The non-transitory computer-readable storage medium of example 16, wherein the second evaluation model generates the test metric according to

$$rND = \frac{1}{opt\_rND} {\sum }_{p}^{N} \frac{1}{{log}_{2} ( p )} \vert \frac{\vert {G}_{1 … p}^{+} \vert}{p} - \frac{\vert {G}^{+} \vert}{N} \vert ,$$

and wherein is the test metric.

Example 18. The non-transitory computer-readable storage medium of example 17, wherein the machine learning model is a trained neural network including: an input layer having a plurality of nodes; one or more hidden layers having a plurality of nodes; and an output layer having a plurality of nodes; wherein: each node of the input layer is connected to at least one node of the one or more hidden layers, each node of the input layer represents a numerical value, the at least one node of the one or more hidden layers receives the numerical value multiplied by a weight as an input, the at least one node of the one or more hidden layers receives the numerical value multiplied by the weight and offset by a bias as the input; and wherein the at least one node of the one or more hidden layers is configured to: sum inputs received from nodes of the input layer, provide the summed inputs to an activation function, and provide an output of the activation function to one or more nodes of a next layer.

Example 19. A system comprising: memory hardware configured to store instructions; and processing hardware configured to execute the instructions, wherein the instructions include: loading a first data set, the first data set including (i) a reference profile and (ii) one or more candidate profiles, providing the first data set to a machine learning model to generate output data, generating telemetry for the first data set, the telemetry including (a) one or more role identifiers associated with the reference profile and (b) one or more candidate identifiers associated with the one or more candidate profiles, processing the output data and telemetry to generate a test metric, in response to the test metric being below a threshold, adjusting the output data, and in response to the test metric being greater than or equal to the threshold, saving the output data as validated output data.

Example 20. The system of example 19 wherein: providing the first data set to the machine learning model to generate output data includes: extracting a control text from the reference profile, generating a first input vector from the control text, providing the first input vector to the machine learning model to generate a first output vector, extracting a candidate text from the one or more candidate profiles, generating a second input vector from the control text, providing the second input vector to the machine learning model to generate a second output vector, and comparing the first output vector with the second output vector to generate a closeness vector; and processing the output data and telemetry to generate a test metric includes: providing an optimal ranked list to a first evaluation model to generate an optimization parameter, initializing a second evaluation model with the optimization parameter, and providing the candidate list to the second evaluation model to generate the test metric.

Example 21. The system of example 20, wherein: first evaluation model generates the optimization parameter according to

$$opt\_rND = \frac{1}{{log}_{2} ( p )} \vert \frac{\vert {G}_{1 … p}^{+} \vert}{p} - \frac{\vert {G}^{+} \vert}{N} \vert ;$$

opt_rND is the optimization parameter; p indicates a number of positions on the optimal ranked list; |G_{1 . . . p}⁺| indicates a number of items in a top p positions on the optimal ranked list that belong to a protected class; |G⁺| indicates a number of items on the optimal ranked list that belong to the protected class; N indicates a total number of items on the optimal ranked list; the second evaluation model generates the test metric according to

$$rND = \frac{1}{opt\_rND} {\sum }_{p}^{N} \frac{1}{{log}_{2} ( p )} \vert \vert \frac{\vert {G}_{1 … p}^{+} \vert}{p} - \frac{\vert {G}^{+} \vert}{N} \vert ;$$

and wherein rND is the test metric.

Example 22. The system of example 20, wherein: the first evaluation model generates the optimization parameter according to

$$opt\_rND = \frac{1}{p} {\sum }_{i = 1}^{p} \frac{1}{{log}_{2} ( i )} \vert \frac{\vert {G}_{1 … i}^{+} \vert}{i} - \frac{\vert {G}^{+} \vert}{N} \vert ;$$

opt_rND is the optimization parameter; p indicates a number of positions on the optimal ranked list; |G_{1 . . . p}⁺| indicates a number of items in a top p positions on the optimal ranked list that belong to a protected class; |G⁺| indicates a number of items on the optimal ranked list that belong to the protected class; and N indicates a total number of items on the optimal ranked list; the second evaluation model generates the test metric according to

$$rND = \frac{1}{opt\_rND} {\sum }_{p}^{N} \frac{1}{{log}_{2} ( p )} \vert \frac{\vert {G}_{1 … p}^{+} \vert}{p} - \frac{\vert {G}^{+} \vert}{N} \vert ;$$

and wherein rND is the test metric.

Example 23. The system of example 21, wherein the machine learning model is a trained neural network including: an input layer having a plurality of nodes; one or more hidden layers having a plurality of nodes; and an output layer having a plurality of nodes; wherein: each node of the input layer is connected to at least one node of the one or more hidden layers, each node of the input layer represents a numerical value, the at least one node of the one or more hidden layers receives the numerical value multiplied by a weight as an input, the at least one node of the one or more hidden layers receives the numerical value multiplied by the weight and offset by a bias as the input; and wherein the at least one node of the one or more hidden layers is configured to: sum inputs received from nodes of the input layer, provide the summed inputs to an activation function, and provide an output of the activation function to one or more nodes of a next layer.

Example 24. A computer-implemented method comprising: loading a first data set, the first data set including (i) a reference profile and (ii) one or more candidate profiles; providing the first data set to a machine learning model to generate output data, generating telemetry for the first data set, the telemetry including (a) one or more role identifiers associated with the reference profile and (b) one or more candidate identifiers associated with the one or more candidate profiles; processing the output data and telemetry to generate a test metric; in response to the test metric being below a threshold, adjusting parameters of the machine learning model; and in response to the test metric being greater than or equal to the threshold, saving the machine learning model as a validated machine learning model; wherein the output data includes a candidate list, the candidate list includes candidates identifiers corresponding to the one or more candidate profiles, and the candidate identifiers are ordered according to a mathematical closeness between each respective candidate profile and the reference profile.

Example 25. The method of example 24, wherein providing the first data set to the machine learning model to generate output data includes: extracting a control text from the reference profile; generating a first input vector from the control text; and providing the first input vector to the machine learning model to generate a first output vector.

Example 26. The method of example 25, wherein providing the first data set to the machine learning model to generate output data includes: extracting a candidate text from the one or more candidate profiles; generating a second input vector from the control text; and providing the second input vector to the machine learning model to generate a second output vector.

Example 27. The method of example 26, wherein providing the first data set to the machine learning model to generate output data includes comparing the first output vector with the second output vector to generate a closeness vector.

Example 28. The method of example 27, wherein processing the output data and telemetry to generate a test metric includes: providing an optimal ranked list to a first evaluation model to generate an optimization parameter; initializing a second evaluation model with the optimization parameter; and providing the candidate list to the second evaluation model to generate the test metric.

Example 29. The method of example 28, wherein: the first evaluation model generates the optimization parameter according to

$$opt\_rND = \frac{1}{{log}_{2} ( p )} \vert \frac{\vert {G}_{1 … p}^{+} \vert}{p} - \frac{\vert {G}^{+} \vert}{N} \vert ;$$

opt_rND is the optimization parameter; p indicates a number of positions on the optimal ranked list; |G_{1 . . . p}⁺| indicates a number of items in a top p positions on the optimal ranked list that belong to a protected class; |G⁺| indicates a number of items on the optimal ranked list that belong to the protected class; and N indicates a total number of items on the optimal ranked list.

Example 30. The method of example 29, wherein: the first evaluation model generates the optimization parameter according to

$$opt\_rND = \frac{1}{p} {\sum }_{i = 1}^{p} \frac{1}{{log}_{2} ( i )} \vert \frac{\vert {G}_{1 … i}^{+} \vert}{i} - \frac{\vert {G}^{+} \vert}{N} \vert ;$$

opt_rND is the optimization parameter; p indicates a number of positions on the optimal ranked list; |G_{1 . . . p}⁺| indicates a number of items in a top p positions on the optimal ranked list that belong to a protected class; |G⁺| indicates a number of items on the optimal ranked list that belong to the protected class; and N indicates a total number of items on the optimal ranked list.

Example 31. The method of example 30, wherein the second evaluation model generates the test metric according to

$$rND = \frac{1}{opt\_rND} {\sum }_{p}^{N} \frac{1}{{log}_{2} ( p )} \vert \frac{\vert {G}_{1 … p}^{+} \vert}{p} - \frac{\vert {G}^{+} \vert}{N} \vert ,$$

and wherein rND is the test metric.

Example 32. The method of example 31, wherein the machine learning model is a trained neural network including: an input layer having a plurality of nodes; one or more hidden layers having a plurality of nodes; and an output layer having a plurality of nodes; wherein: each node of the input layer is connected to at least one node of the one or more hidden layers, each node of the input layer represents a numerical value, the at least one node of the one or more hidden layers receives the numerical value multiplied by a weight as an input, the at least one node of the one or more hidden layers receives the numerical value multiplied by the weight and offset by a bias as the input; and wherein the at least one node of the one or more hidden layers is configured to: sum inputs received from nodes of the input layer, provide the summed inputs to an activation function, and provide an output of the activation function to one or more nodes of a next layer.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

The term computer-readable medium does not encompass transitory electrical or electromagnetic signals or electromagnetic signals propagating through a medium-such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

What is claimed is:

1. A system comprising:
memory hardware configured to store instructions; and
processing hardware configured to execute the instructions, wherein the instructions include:
loading a first data set, the first data set including (i) a reference profile and (ii) one or more candidate profiles,
providing the first data set to a machine learning model to generate output data,
generating telemetry for the first data set, the telemetry including (a) one or more role identifiers associated with the reference profile and (b) one or more candidate identifiers associated with the one or more candidate profiles,
processing the output data and telemetry to generate a test metric,
in response to the test metric being below a threshold, adjusting parameters of the machine learning model, and
in response to the test metric being greater than or equal to the threshold, saving the machine learning model as a validated machine learning model;
wherein the output data includes a candidate list, the candidate list includes candidates identifiers corresponding to the one or more candidate profiles, and the candidate identifiers are ordered according to a mathematical closeness between each respective candidate profile and the reference profile.

2. The system of claim 1 wherein providing the first data set to the machine learning model to generate output data includes:
extracting a control text from the reference profile;
generating a first input vector from the control text; and
providing the first input vector to the machine learning model to generate a first output vector.

3. The system of claim 2 wherein providing the first data set to the machine learning model to generate output data includes:
extracting a candidate text from the one or more candidate profiles;
generating a second input vector from the control text; and
providing the second input vector to the machine learning model to generate a second output vector.

4. The system of claim 3 wherein providing the first data set to the machine learning model to generate output data includes comparing the first output vector with the second output vector to generate a closeness vector.

5. The system of claim 4 wherein processing the output data and telemetry to generate a test metric includes:
providing an optimal ranked list to a first evaluation model to generate an optimization parameter;
initializing a second evaluation model with the optimization parameter; and
providing the candidate list to the second evaluation model to generate the test metric.

6. The system of claim 5 wherein:
the first evaluation model generates the optimization parameter according to
$$opt\_rND = \frac{1}{{log}_{2} ( p )} \vert \frac{\vert {G}_{1 … p}^{+} \vert}{p} - \frac{\vert {G}^{+} \vert}{N} \vert ;$$
opt_rND is the optimization parameter;
p indicates a number of positions on the optimal ranked list;

|G_{1 . . . p}⁺| indicates a number of items in a top p positions on the optimal ranked list that belong to a protected class;

|G⁺| indicates a number of items on the optimal ranked list that belong to the protected class; and
N indicates a total number of items on the optimal ranked list.

7. The system of claim 5 wherein:
the first evaluation model generates the optimization parameter according to
$$opt\_rND = \frac{1}{p} {\sum }_{i = 1}^{p} \frac{1}{{log}_{2} ( i )} \vert \frac{\vert {G}_{1 … i}^{+} \vert}{i} - \frac{\vert {G}^{+} \vert}{N} \vert ;$$
opt_rND is the optimization parameter;
p indicates a number of positions on the optimal ranked list;

|G_{1 . . . p}⁺| indicates a number of items in a top p positions on the optimal ranked list that belong to a protected class;

|G⁺| indicates a number of items on the optimal ranked list that belong to the protected class; and
N indicates a total number of items on the optimal ranked list.

8. The system of claim 7 wherein the second evaluation model generates the test metric according to
$$rND = \frac{1}{opt\_rND} {\sum }_{p}^{N} \frac{1}{{log}_{2} ( p )} \vert \frac{\vert {G}_{1 … p}^{+} \vert}{p} - \frac{\vert {G}^{+} \vert}{N} \vert ,$$
and wherein rND is the test metric.

9. The system of claim 8 wherein the machine learning model is a trained neural network including:
an input layer having a plurality of nodes;
one or more hidden layers having a plurality of nodes; and
an output layer having a plurality of nodes;
wherein:
each node of the input layer is connected to at least one node of the one or more hidden layers,
each node of the input layer represents a numerical value,
the at least one node of the one or more hidden layers receives the numerical value multiplied by a weight as an input,
the at least one node of the one or more hidden layers receives the numerical value multiplied by the weight and offset by a bias as the input; and
wherein the at least one node of the one or more hidden layers is configured to:
sum inputs received from nodes of the input layer,
provide the summed inputs to an activation function, and
provide an output of the activation function to one or more nodes of a next layer.

10. A non-transitory computer-readable storage medium comprising executable instructions, wherein the executable instructions cause an electronic processor to:
load a first data set, the first data set including (i) a reference profile and (ii) one or more candidate profiles;
provide the first data set to a machine learning model to generate output data,
generate telemetry for the first data set, the telemetry including (a) one or more role identifiers associated with the reference profile and (b) one or more candidate identifiers associated with the one or more candidate profiles;
process the output data and telemetry to generate a test metric;
in response to the test metric being below a threshold, adjust parameters of the machine learning model; and
in response to the test metric being greater than or equal to the threshold, save the machine learning model as a validated machine learning model;
wherein the output data includes a candidate list, the candidate list includes candidates identifiers corresponding to the one or more candidate profiles, and the candidate identifiers are ordered according to a mathematical closeness between each respective candidate profile and the reference profile.

11. The non-transitory computer-readable storage medium of claim 10 wherein the executable instructions cause the electronic processor to provide the first data set to the machine learning model to generate output data by:
extracting a control text from the reference profile;
generating a first input vector from the control text; and
providing the first input vector to the machine learning model to generate a first output vector.

12. The non-transitory computer-readable storage medium of claim 11 wherein the executable instructions cause the electronic processor to provide the first data set to the machine learning model to generate output data by:
extracting a candidate text from the one or more candidate profiles;
generating a second input vector from the control text; and
providing the second input vector to the machine learning model to generate a second output vector.

13. The non-transitory computer-readable storage medium of claim 12 wherein providing the first data set to the machine learning model to generate output data includes comparing the first output vector with the second output vector to generate a closeness vector.

14. The non-transitory computer-readable storage medium of claim 13 wherein the executable instructions cause the electronic processor to process the output data and telemetry to generate a test metric by:
providing an optimal ranked list to a first evaluation model to generate an optimization parameter;
initializing a second evaluation model with the optimization parameter; and
providing the candidate list to the second evaluation model to generate the test metric.

15. The non-transitory computer-readable storage medium of claim 14 wherein:
the first evaluation model generates the optimization parameter according to
$$opt\_rND = \frac{1}{{log}_{2} ( p )} \vert \frac{\vert {G}_{1 … p}^{+} \vert}{p} - \frac{\vert {G}^{+} \vert}{N} \vert ;$$
opt_rND is the optimization parameter;
p indicates a number of positions on the optimal ranked list;

|G_{1 . . . p}⁺| indicates a number of items in a top p positions on the optimal ranked list that belong to a protected class;

|G⁺| indicates a number of items on the optimal ranked list that belong to the protected class; and
N indicates a total number of items on the optimal ranked list.

16. The non-transitory computer-readable storage medium of claim 15 wherein:
the first evaluation model generates the optimization parameter according to
$$opt\_rND = \frac{1}{p} {\sum }_{i = 1}^{p} \frac{1}{{log}_{2} ( i )} \vert \frac{\vert {G}_{1 … i}^{+} \vert}{i} - \frac{\vert {G}^{+} \vert}{N} \vert ;$$
opt_rND is the optimization parameter;
p indicates a number of positions on the optimal ranked list;

|G_{1 . . . p}⁺| indicates a number of items in a top p positions on the optimal ranked list that belong to a protected class;

|G⁺| indicates a number of items on the optimal ranked list that belong to the protected class; and
N indicates a total number of items on the optimal ranked list.

17. The non-transitory computer-readable storage medium of claim 16 wherein the second evaluation model generates the test metric according to
$$rND = \frac{1}{opt\_rND} {\sum }_{p}^{N} \frac{1}{{log}_{2} ( p )} \vert \frac{\vert {G}_{1 … p}^{+} \vert}{p} - \frac{\vert {G}^{+} \vert}{N} \vert ,$$
and wherein rND is the test metric.

18. The non-transitory computer-readable storage medium of claim 17 wherein the machine learning model is a trained neural network including:
an input layer having a plurality of nodes;
one or more hidden layers having a plurality of nodes; and
an output layer having a plurality of nodes;
wherein:
each node of the input layer is connected to at least one node of the one or more hidden layers,
each node of the input layer represents a numerical value,
the at least one node of the one or more hidden layers receives the numerical value multiplied by a weight as an input,
the at least one node of the one or more hidden layers receives the numerical value multiplied by the weight and offset by a bias as the input; and
wherein the at least one node of the one or more hidden layers is configured to:
sum inputs received from nodes of the input layer,
provide the summed inputs to an activation function, and
provide an output of the activation function to one or more nodes of a next layer.

19. A system comprising:
memory hardware configured to store instructions; and
processing hardware configured to execute the instructions, wherein the instructions include:
loading a first data set, the first data set including (i) a reference profile and (ii) one or more candidate profiles,
providing the first data set to a machine learning model to generate output data,
generating telemetry for the first data set, the telemetry including (a) one or more role identifiers associated with the reference profile and (b) one or more candidate identifiers associated with the one or more candidate profiles,
processing the output data and telemetry to generate a test metric,
in response to the test metric being below a threshold, adjusting the output data, and
in response to the test metric being greater than or equal to the threshold, saving the output data as validated output data.

20. The system of claim 19 wherein:
providing the first data set to the machine learning model to generate output data includes:
extracting a control text from the reference profile,
generating a first input vector from the control text,
providing the first input vector to the machine learning model to generate a first output vector,
extracting a candidate text from the one or more candidate profiles,
generating a second input vector from the control text,
providing the second input vector to the machine learning model to generate a second output vector, and
comparing the first output vector with the second output vector to generate a closeness vector; and
processing the output data and telemetry to generate a test metric includes:
providing an optimal ranked list to a first evaluation model to generate an optimization parameter,
initializing a second evaluation model with the optimization parameter, and
providing the candidate list to the second evaluation model to generate the test metric.
